(19) United States
(12) Patent Application Publication
(10) Pub. No.: US 2007/0172345 A1
(43) Pub. Date: Jul. 26, 2007

(54) Screw-centrifugal pump

(76) Inventor: Martin Stahle, Neunkirch (CH)

Correspondence Address: PEARL COHEN ZEDEK LATZER, LLP, 1500 BROADWAY 12TH FLOOR, NEW YORK, NY, 10036, US

(21) Appl. No.: 10/588,736

(22) PCT Filed: Nov. 2, 2004
(86) PCT No.: PCT/CH04/00664

§ 371 Date: Aug. 8, 2006

(30) Foreign Application Priority Data
Apr. 7, 2004 (EP) 04405214.0

(51) Int. Cl. F03B 3/12

(52) U.S. Cl. 415/71

(57) ABSTRACT

A screw-centrifugal pump (1) comprises a pump housing (3) having an inlet opening (3c) and also an impeller (2) arranged within the pump housing (3) and rotatable about an axis of rotation (2d) in a direction of rotation (4a). The impeller (2) has a spirally extending blade entry edge (2a) and a guide vane (5) projects into the interior space of the impeller (2) and is disposed in the region of the inlet opening (3c). A method of conveying a liquid permeated with solid additions using such a pump is also described and claimed.

The invention relates to a screw-centrifugal pump in accordance with the preamble of claim 1. The invention further relates to a method for the conveying of a medium with a screw-centrifugal pump in accordance with the preamble of claim 9.

A screw-centrifugal pump also termed a screw pump is known from the document CH 394814. A rotary pump of this kind includes a single helically extending blade which is rotatably disposed in a pump housing. This pump is in particular suitable for conveying liquids permeated with solid additions, in particular for conveying waste water with long fibrous components.

The possibility of pumping liquid with a high concentration of fibrous solid materials which tend for example to tress formation is restricted. This can lead to deposits of solid components in the pumping path or to a blockage caused thereby right up to pump stoppage.

The invention is based on the object of providing a screw-centrifugal pump which has more advantageous characteristics in conveying liquids permeated with solid additions.

This object is satisfied with a screw-centrifugal pump having the features of claim 1. The subordinate claims 2 to 8 relate to further advantageous embodiments. The object is further satisfied by a method having the features of claim 9.

The object is in particular satisfied with a screw-centrifugal pump comprising a pump housing having an inlet opening and also an impeller arranged within the pump housing and rotatable about an axis of rotation in a direction of rotation, the impeller having a spirally extending blade entry vein edge, with a guide vane projecting into the interior space of the impeller being disposed in the region of the inlet opening.

In a particular advantageous design the guide vane of the screw-centrifugal pump has a guide vane edge which, in the direction of rotation of the impeller, increasingly projects in the direction of flow into the interior space towards the centre of the impeller. The screw-centrifugal pump in accordance with the invention is in particular advantageous when pumping high concentrations of fibrous materials which tend to tress formation. If the solid concentration of the floated in, fibrous, solid material continuously increases then this leads to ball formation in the suction line and to an increased friction in the impeller passage. If, in this connection, a certain limiting value is achieved, then the hydraulic forces alone are no longer able to pump the material which has the consequence that the screw-centrifugal pump clogs up and blocks. The screw-centrifugal pump of the invention prevents this blockage in that the spiral blade entry edge of the start of the screw section of the impeller rotates relative to the fixedly arranged projecting guide vane, with the blade entry edge and the guide vane cooperating in such a way that the solid masses located between them are engaged by the rotating blade entry edge and loosened up and/or pressed in the flow direction along the blade entry edge. Through this cooperation of the guide vane and the screw-centrifugal impeller a mechanical force acting substantially in the pump direction is exerted on the conveying medium, in addition to the hydraulic forces, which prevents an accumulation of solid components in the pump path.

In a further advantageous embodiment, the guide vane edge forms a fixed three-dimensional curve and the blade entry edge forms a rotatable three-dimensional curve as a result of the rotatable screw-centrifugal impeller, with these two three-dimensional curves preferably being designed so that they are matched to one another and extend in such a way that they move past one another on rotation of the impeller with a small mutual spacing, or mutually contacting one another. The solid materials located between the two three-dimensional curves are thereby moved mechanically in the direction of extent of the three-dimensional curves and are thereby substantially moved in the flow direction and loosened up or pressed in the flow direction.

In a further advantageous embodiment the guide vane edge and/or the blade entry edge have a cutting edge, at least in part, so that the solid materials between the mutually moving three-dimensional curves can also be additionally mechanically weakened or comminuted. With solid materials which tend to tress formation this brings about a weakening, loosening up, comminution or cutting of the tresses or fibres, which prevents an accumulation of the tresses in the pump path and thus ensures a continuous reliable operation of the screw-centrifugal pump without interruption.

The mutual shearing, parting or clamping action of the two three-dimensional curves also enables, independently of the design of the guide vane edge and/or of the blade entry edge, a cutting through, comminution or weakening of fibrous solid materials such as paper, cords, wood or solid materials such as plastic, rubber, metal or glass.

The invention will be described in more detail in the following with reference to embodiments. There are shown:

FIG. 1 an axial section through a screw-centrifugal pump;

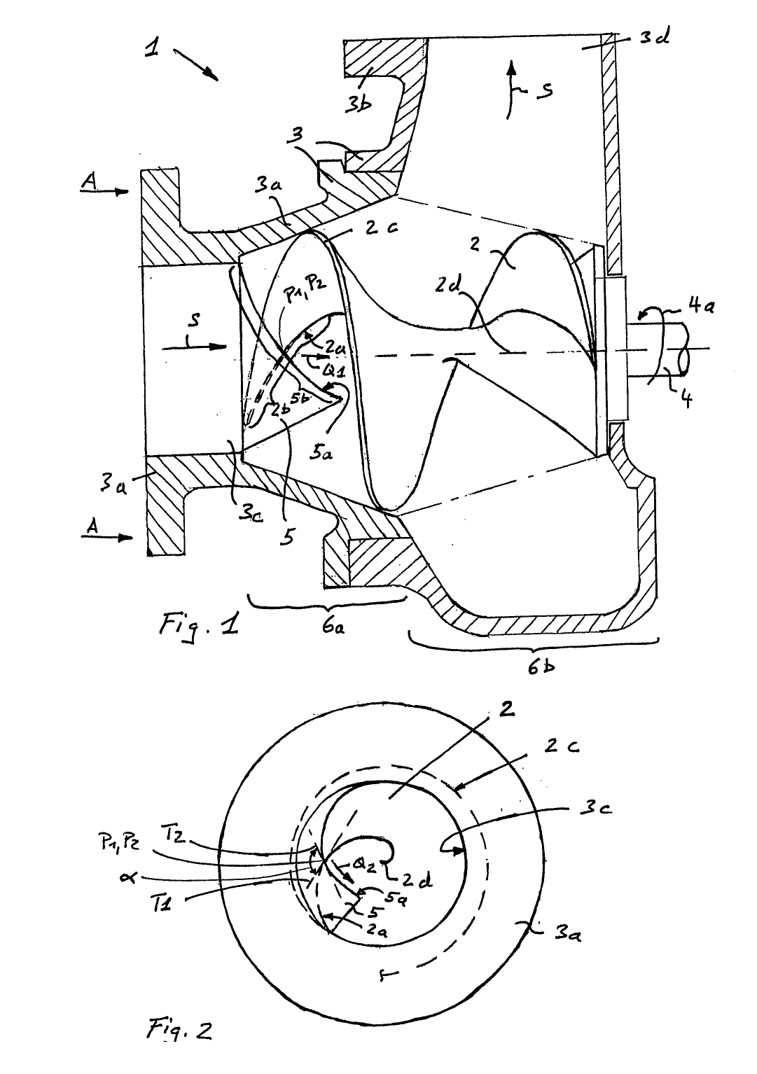

FIG. 2 a front view of the entry opening of the screw-centrifugal pump;

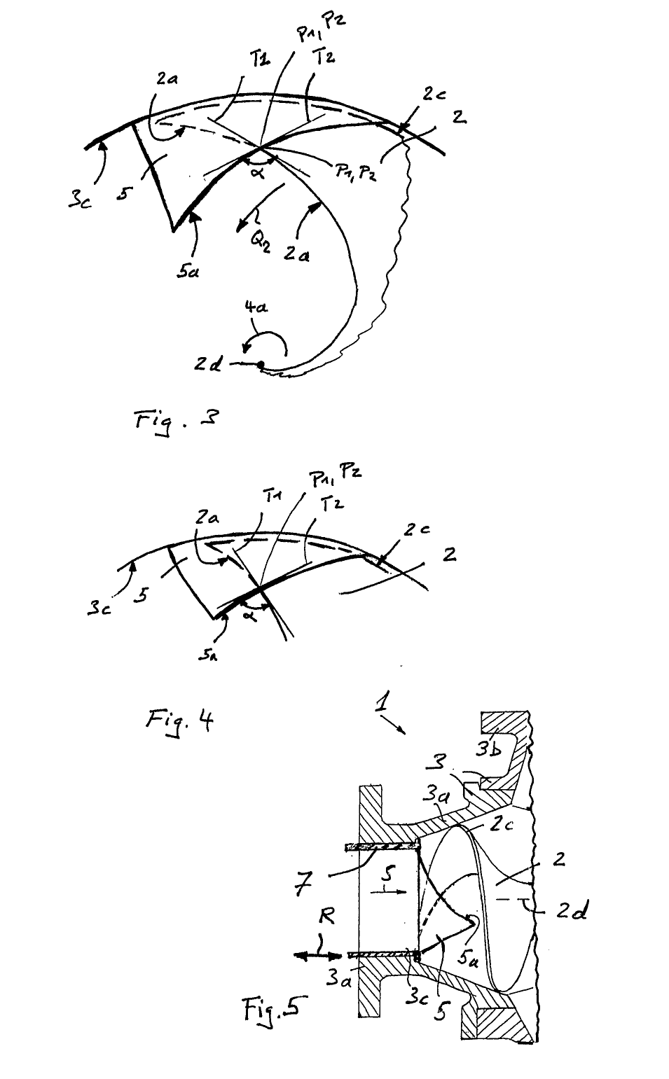

FIGS. 3 and 4 two different total angles of the blade entry edge and the guide vane edge; and

FIG. 5 displaceably arranged guide vane.

The screw-centrifugal pump 1 of FIG. 1 includes a screw-centrifugal impeller 2 which is disposed in a pump housing 3 and is rotatable about an axis of rotation 2d in a direction of rotation 4a. The screw-centrifugal impeller 2 has a spirally extending blade entry edge 2a and also an outer contour 2c. The screw-centrifugal impeller 2 is fixedly connected to a pump shaft 4. The pump housing 3 includes a conical suction housing part 3a, a spiral housing part 3b, an inlet opening 3c and also an outlet opening 3d. A projecting guide vane 5 having a guide vane edge 5a is fixedly arranged in the region of the inlet opening 3c and is projecting in the inner space of the pump housing 3 and also in the interior space of the screw-centrifugal impeller 2. In the present document the term “interior”space of the impeller 2″ will be understood to mean the interior space which, when the screw-centrifugal impeller 2 is rotating, is bounded by the outer contour 2c so that the guide vane 5 at least partly extends into this interior space and the screw-centrifugal impeller 2 surrounds the guide vane 5 outwardly, as shown in FIG. 1, in the region of the apex of the screw-centrifugal impeller 2 or, at a maximum, within the screw section 6a. The screw-centrifugal pump 1 also includes a screw section 6a and a centrifugal section 6b. The medium pumped by the pump 1 flows in the flow direction S.

FIG. 2 shows a front view of the inlet opening 3c in the direction designated A in FIG. 1, with the impeller 2 and also the guide vane 5 being recognizable in the interior of the pump 1. For the impeller 2 the spirally extending blade entry edge 2a is evident which drops off towards the axis of rotation 2d and grows axially into the latter. The front-most section of the blade entry edge 2a is not directly visible because of the guide vane 5 and has therefore been drawn in broken lines.

In the FIGS. 1 and 2 the guide vane 5 is designed in such a way that the guide vane edge 5a projects, in the direction of rotation 4a, increasingly in the direction of the axis of rotation 2d, both in the radial direction and also in the axial direction into the interior space of the impeller 2. The guide vane edge 5a forms a fixed three-dimensional curve whereas the blade entry edge 3a forms a three-dimensional curve rotatable about the impeller axis 2d. These two three-dimensional curves 2a, 5a are designed in the illustrated embodiment such that they are mutually matched and extend in such a way that the guide vane edge 5a forms a guide vane edge section 5b and the blade entry edge 2a has a blade edge section 2b within which the guide vane edge 5a and the blade entry edge 2a have a small mutual spacing from one another, in dependence on the respective position of the impeller 2, or mutually touch one another. The small mutual spacing can for example have a value between 0.1 and 30 mm. This position with the smallest possible spacing is illustrated by the point P1 on the blade edge section 2b and also by the point P2 on the guide vane edge section 5b. As a result of the rotation of the impeller 2 the direction of rotation 4a the points P1, P2 move, in the view shown in FIG. 1, essentially in the direction Q1 of the axis of rotation 2d, and substantially in the direction Q2 in the view shown in FIG. 2, corresponding to the shape of the guide vane edge 5a. In this way a solid material located between the blade edge section 2b and the guide vane edge section 5b is mechanically conveyed essentially in the direction Q1, i.e. in the flow direction S.

The guide vane 5 can be arranged in the most diverse manner in the pump housing and designed such that the fixed guide vane edge 5a and the rotating blade entry edge 2a cooperate in such a way that solid materials are mechanically conveyed by the mutual collaboration by the edges 2a, 5a, in particular in the flow direction S.

As evident from FIG. 2 the blade edge section 2b has a tangent T1 at the point P1 and the guide vane edge section 5b has a tangent T2 at a point P2, with these two tangents T1, T2 having an intersection angle a when considered from the entry opening 3c, as illustrated. The angle a amounts to at least 10 degrees and lies preferably between 30 degrees and 150 degrees, in particular between 60 degrees and 120 degrees. The angle a is preferably never smaller than that angle at which a sliding of the solid material on the blade entry edge 2a or between the blade entry edge 2a and the guide vane edge 5a is no longer ensured.

FIGS. 3 and 4 show in two detailed views, analogously to the illustration of FIG. 2, two differently extending three-dimensional curves, i.e. the blade entry edge 2a and the guide vane edge 5a, with the enclosed angle a of the tangents T1, T2 at the points P1, P2 in FIG. 3 amounting to approximately 110 degrees and in FIG. 4 to approximately 90 degrees. This angle a is determined by the course of the three-dimensional curves 2a, 5a and can thus be correspondingly selected in the design of the screw-centrifugal pump 1. The course of the three-dimensional curves 2a, 5a can be selected in such a way that the angle a remains substantially constant during the movement of the points P1, P2 in the direction Q2. Through correspondingly extending three-dimensional curves 2a, 5a, the angle a can also increase and/or decrease during the movement of the points P1, P2 in the direction Q2.

In an advantageous design at least one part of the blade edge section 2b and/or of the guide vane edge section 5b is formed as an edge, cutting edge or blade in order to weaken or to cut through solid material which is located between the sections 2b, 5b.

In general, the larger the angle a is selected to be, the more a solid material is pushed along the edge sections 2b, 5b or, respectively, the smaller the angle a is selected to be the more easily is a solid material parted by the edge sections 2b, 5b. In addition, through appropriate shaping, the length of the effective edge sections 2b, 5b can be determined. Thus the screw-centrifugal pump can be optimized in accordance with the solid materials and additions that are to be expected in such a way that the edge sections 2b, 5b and their angle a are selected in a correspondingly optimized manner in order to prevent a clogging up of the pump, and for example, to additionally achieve a good pumping efficiency.

FIG. 5 shows a further embodiment of a screw-centrifugal pump 1 in the inlet opening 3c of which a wear-resistance sleeve 7 is disposed which is fixedly connected to the guide vane 5. The sleeve 7 can be firmly connected to the pump housing 3 by an attachment means which is not illustrated.

When the fastening means are released, the sleeve 7 and thus also the guide vane 5 is displaceable in the direction of movement R. This arrangement has, in particular, the advantage that the distance between the blade entry edge 2a and the guide vane edge 5a can be adjusted, in particular the spacings of the points P1, P2 in the direction R or Q1 respectively. The blade entry edge 2a and/or the guide vane edge 5a wear during the operation of the pump so that the distance of the points P1, P2 increases in operation in the course of time. The sleeve 7 thus enables the position of the guide vane 5 to be reset anew in the direction of displacement R or Q1 respectively after certain time intervals. The sleeve 7 can also be designed in such a way that it is also rotatable in the entry opening 3c, i.e. is rotatable with respect to the impeller axis 2d, in order to rotate the sleeve 7 in the released state and thus also to rotate the position of the guide vane 5.

1. (canceled)

2. A screw centrifugal pump in accordance with claim 11, wherein the guide vane is displaceable in the direction of the axis of rotation and is fixably mounted.

3. A screw-centrifugal pump in accordance with claim 11, wherein the guide vane has a guide vane edge which, in the direction of rotation increasingly projects in the direction of the axis of rotation the interior space of the impeller.

4. (canceled)

5. (canceled)

6. A screw-centrifugal pump in accordance with claim 13, wherein the blade edge section has a first tangent at the first point, the guide vane edge section has a second tangent at the second point and the first and second tangents form an intersection angle of at least 10 degrees in a plane perpendicular to the axis of rotation.

7. A screw-centrifugal pump in accordance with claim 6, wherein the intersection angle is between 30 degrees and 180 degrees.

8. A screw-centrifugal pump accordance with claim 12, wherein the blade edge section or the guide vane edge section formed at least partly as a cutting edge.

9. A method for the conveying of a liquid permeated with solid additions using a screw-centrifugal pump wherein the liquid is directed with the aid of a guide vane a blade entry edge of a rotating impeller in such a way that at least one part of the solid additions slides along the blade entry edge.

10. A method in accordance with claim 9, wherein a guide vane edge of the guide vane and the blade entry edge mutually cooperate when the impeller is rotating such that the solid addition located between the blade entry edge and the guide vane edge is mechanically comminuted by the blade and vane edges or shifted in the directions that rotating the impeller causes materials to flow.

11. A screw-centrifugal pump comprising:
a pump housing;
an inlet opening;
an impeller comprising a spirally extending blade entry edge that rotates about an axis of rotation in a direction for carrying material away from the inlet opening; and
a guide vane, wherein the guide vane is disposed near the inlet opening and projects into an interior space surrounding the impeller.

12. A screw-centrifugal pump in accordance with claim 3, wherein the guide vane edge includes a guide blade edge section and forms a fixed three-dimensional curve and the blade entry edge includes a blade edge section and forms a rotatable three-dimensional curve, wherein the fixed and rotatable three-dimensional curves extend in a mutually matched manner such the guide vane edge and the blade entry edge have a mutual spacing or mutually touch one another, depending on the position of the impeller.

13. A screw-centrifugal pump in accordance with claim 12, comprising:
a first point on the blade edge section; and
a second point on the guide vane edge section, wherein the first point and the second point have the smallest mutual spacing between them of any two points on the first edge section and the guide vane edge section, respectively, and wherein rotating the impeller causes the first point and the second point to move along the axis of rotation in the same direction as fluids.

14. A screw-centrifugal pump in accordance with claim 11 wherein the guide vane is fixed to the inlet opening.
